(19) United States
(12) Patent Application Publication
(10) Pub. No.: US 2011/0168185 A1
(43) Pub. Date: Jul. 14, 2011

(54) LINER FOR ENCLOSING A BODY PART DURING AN IMAGING PROCEDURE

(75) Inventor: Bernd Schottdorf, Dischingen (DE)

(73) Assignee: KLA-Tencor Corporation, Milpitas, CA (US)

(21) Appl. No.: 13/054,410

(22) PCT Filed: Jul. 14, 2009
(86) PCT No.: PCT/EP09/05119

§ 371 Date: Mar. 21, 2011

(30) Foreign Application Priority Data
Jul. 14, 2008 (DE) 10 2008 032 992.4

(51) Int. Cl. A61G 15/00

(52) U.S. Cl. 128/845

(57) ABSTRACT

Liner (100a; 100b; 200a; 200b; 300; 400) to at least partially enclose a body part (205a; 205b; 305) during an imaging procedure, and use of a liner (100a; 100b; 200a; 200b; 300; 400) in a device that simulates the weight acting on the body part (205a; 205b; 305) essentially parallel to the longitudinal axis of the body part (205a; 205b; 305), and the use of a liner (100a; 100b; 200a; 200b; 300; 400) to create a virtual 3D model of the body part (205a; 205b; 305). The liner (100a; 100b; 200a; 200b; 300; 400) is suitable to hold the body part (205a; 205b; 305) essentially in a predetermined shape, wherein the liner (100a; 100b; 200a; 200b; 300; 400) can be placed on the skin surface of the body part (205a; 205b; 305) in an essentially form-fitting manner. The liner (100a; 100b; 200a; 200b; 300; 400) contains a material comprising a base material in which at least one contrast medium is essentially homogeneously distributed. The contrast medium is suitable to enhance the contrast of the liner material with respect to the skin tissue (201a; 201b; 301) in the generated image data relative to the contrast of the base material with respect to the skin tissue when the liner (100a; 100b; 200a; 200b; 300; 400) is used on the body part (205a; 205b; 305) during the imaging procedure.

### FIELD OF THE INVENTION

The present invention pertains to a liner to at least partially encompass a part of the body during an imaging procedure, the use of the liner to simulate the weight of the body part during an imaging procedure, and the use of the liner to create a virtual, 3D model of a body part.

### BACKGROUND OF THE INVENTION

Imaging procedures have found wide application in medical diagnostics. In this way, information about the geometry of a part of the body or the tissue distribution inside an organism can be visualized and determined. In addition, diseased tissue such as tumors or inflammatory foci can be identified. Imaging procedures that are used especially frequently are magnetic resonance imaging (MRI) and computed tomography (CT). In an MRI, an image is generated based on the interaction of the tissue with applied electromagnetic radiation characteristic for each tissue. In CT, the contrast among the various tissues is based on the attenuation of the X-ray radiation characteristic for each type of tissue.

As a result of design issues, the patient is frequently in a horizontal position during the imaging. The action of gravity displaces various tissues resulting in a lateral deformation of the imaged body part. In a subsequent evaluation of the image data concerning the position of the tissue, this lateral deformation can lead to miscalculations. This lateral deformation may lead to false conclusions, especially in examinations that are intended to shed light on the geometry and position or the distribution of different types of tissues.

There are known devices that support or secure the body or body part during the imaging procedure. The body or body part is positioned in such a way that the desired images can be obtained or the recording process can be made as comfortable as possible for the patient. Immobilizing the body or body part also serves to reduce movement artifacts. These known devices cannot prevent gravity-induced, lateral deformation of the body part being imaged.

Moreover there are known liners that are worn between the stump and the prosthesis socket to improve the comfort of the prosthetics patient. In this instance the liner material provides the skin of the stump with mechanical protection against abrasion and also provides an additional surface that better adheres to the socket than the skin, therefore allowing for better transmission of force. Materials that are typically used in the manufacture of the liner such as polyurethane, silicone or textile fiber materials are poorly depicted in imaging procedures.

Because of the physical principles on which the imaging procedure is based, the imaging capability of every imaging procedure is limited to specific applications. For example, adjacent tissues with the same or similar physical properties are difficult to distinguish in the images, for example. In this case, segmentation of the image data, or in other words, the assignment of image pixels to the individual tissues, is difficult and time-consuming.

The contrast between adjacent tissues may be increased by administering a tissue-specific contrast medium. This procedure is not suitable for distinguishing adjacent tissues of the same type in different body parts, particularly in separating layers of skin from one another.

If two body parts with the same tissue type are situated directly next to one another, the boundary between the two body parts can be difficult to determine using the images.

The task of the invention is therefore to provide a liner for imaging procedures that overcomes the aforementioned hindrances.

### SUMMARY OF THE INVENTION

According to the invention, this problem is solved by the subject matter of the independent claims. Variants and preferred embodiments result from and are dependent on the following descriptions and the drawings.

One aspect of the invention concerns a liner used to at least partially enclose a body part during an imaging procedure. The liner is suitable for keeping the body part essentially in a specified shape. At the same time, the liner can be placed with approximately a form fit on the skin surface of the body part. In addition, the liner has a material that comprises a base material in which at least one contrast medium is distributed in an essentially homogeneous manner. When the liner is used on a body part during the imaging procedure, said contrast medium is suitable to intensify the contrast of the liner material with respect to the skin tissue in the generated image data relative to the contrast of the base material with respect to the skin tissue.

It is advantageous that three-dimensional image data are acquired in the imaging procedure using magnetic resonance imaging (MRI) and/or computed tomography (CT). Other imaging procedures such as positron emission tomography (PET) or ultrasound procedures can also be used however.

The body part being imaged generally includes various types of tissue such as skin, fat, muscle and bone and is delimited by an external layer of skin.

The liner is preferably made of a material that is elastic and thus reversibly deformable so that the liner can placed on the patient's body part in a form fit without the formation of air pockets. This means that unevenness in the skin surface can be modeled faithfully by the liner. In the case of scar tissue, the high degree of adaptability and malleability of the liner material is particularly advantageous. In addition, the liner material also displays a certain tensile and compressive strength for shaping the body part being imaged. In so doing, the liner preferably exerts an even pressure on the body part. Alternatively, the pressure can be distributed across the surface of the body part unevenly.

The base material is preferably a polymer compound. In addition to the base material, which is responsible for the elastic properties of the liners, the liner material also contains a contrast medium. This is preferably a substance that generates a signal during an imaging procedure that is clearly distinguishable from the signal of the skin tissue. The signal can be stronger or weaker than the signal of the skin tissue. The signal strength of the liner material is preferably raised by the contrast medium to a value that falls between the signal strength of bone and muscle tissue in order to enable subsequent, automated segmentation. For magnetic resonance imaging, for example, compounds containing gadolinium or superparamagnetic iron oxide are preferred. Manganese or nickel compounds can also be used, however. In the case of computed tomography, it is advantageous to use compounds containing iodine.

As a result of this enhanced contrast created between the skin and the liner, the identification of the external surfaces of the body part is simplified in the recorded images. For example, two body parts can lie directly adjacent to one another during imaging. Without using the inventive liner, the skin tissue of the first body part directly abuts the skin tissue of the second body part. This is the case, for example, when imaging a male patient's thigh and his genitals. In the images, the skin tissue of the body parts are represented by the same or a similar grayscale since both skin tissues generate approximately the same signals. It is therefore difficult to separate the body parts in the images by identifying the surfaces. Moreover the image noise makes recognition based on minimal differences in brightness in the images more difficult. The surface of the enclosed body part is identifiable in 3D image data as a result of the enhanced contrast between the liner material and the skin tissue of the enclosed body part. Identification of the surface of the body part can be done manually, semi-automatically or automatically. In the case of automated segmentation algorithms, the individual pixels in the visualization are assigned to different types of tissues. This assignment can be done by means of threshold analysis of the grayscale values for each individual pixel, for example. In particular, the contrast enhancement between the liner material and the skin tissue can have a positive effect in the use of automated segmentation algorithms to identify a surface of a body part. The effect of image noise is especially reduced by contrast enhancement. The clearer the contrast of the liner material with respect to the tissue enclosed by the liner, the more effectively the automated segmentation algorithm can be used. By clearly delimiting the skin tissue from the surrounding body parts, the segmented body part surface can be used in particular to create a precise, virtual 3D model of the body part that describes the surface shape of the body part true to detail.

According to an embodiment of the invention, the specific shape in which the body part is held is the shape of the body part that ensues when that body part is in a defined position or posture. In particular, the body part is held in a shape that the body part assumes when the body is standing, i.e., in an upright position. Of particular interest is the visualization of legs, preferentially in an upright position in which a great deal of force is exerted, for example when walking. During imaging procedures such as a CT or MRI, on the other hand, the patient is typically positioned supine in the cradle which can lead to the deformation of the body part being imaged. With this embodiment, the body part is hence imaged in a position that is relevant to the further processing of the image data. An example of such preferred further processing is a virtual 3D model of the stump that is then used as the basis for creating a prosthetic socket.

According to another embodiment of the invention, the body part is a limb stump. For example, the limb stump is a thigh stump. Moreover the liner is suitable for completely enclosing the stump.

In the manufacture of prosthetic sockets for amputees, it is particularly advantageous to be able to create detailed, realistic virtual visualizations of the stump and in particular, to create 3D models of the stump on the basis of which form-fitting prosthesis sockets can be constructed. The contour of the skin surface can be represented precisely in images from the imaging procedure via the liner in the 3D image data and reconstructed using segmentation. In particular in the case of male transfemoral amputations, the use of the liner allows for an automated medial separation of the stump tissue and the tissue of the genitals.

Preferably, the specific shape in which the stump is held corresponds to the shape of the stump in which the stump is found in an upright or in other words vertical position. This is especially the position of a stump in which the greatest mechanical forces are acting on the stump. A thigh stump in particular is subjected to heavy strain when walking using a prosthetic.

As a result of the characteristic shape properties of the liner material, the stump can be kept in the specified shape during the imaging. In particular, the liner significantly prevents a lateral deformation of the body part when the stump is in a horizontal or lying position. This is particularly beneficial in imaging procedures in which the stump is imaged in a lying position. The lateral deformation and flattening in a lying position largely results from the fact that gravity is exerting its force on the stump perpendicular to the body's axis. With the liner placed on the body part, the position of the various tissues in an upright position is preferably retained. Improved visualization of the actual tissue distributions in the stump can be advantageously achieved during imaging. This allows for improved diagnosis and more accurate measurement of the stump, for example using software designated for that purpose.

According to another embodiment of the invention, the base material of the liner comprises polyurethane, silicone and/or thermoplastic elastomers or the like. Every substance used as a base material displays characteristic material properties. Polyurethane is for example a polymer compound comprising polyols and polyisocyanates. It is characterized by a relatively high viscoelasticity and therefore is preferred for making an exact replica of an uneven, especially scarred skin surface. The mechanical properties can be advantageously adjusted to the specific demands of an examination by an imaging method, or to the anatomy of the body part, using a variation of the polyol compound used and/or the concentration of the two precursors. In polymerized form, in which the individual components are three-dimensionally cross-linked using urethane groups; polyurethane also displays no toxic properties so that the material can be used in medicine and/or medical technology. Polyurethane can be used as a gel, elastomer or polyurethane foam for the manufacture of a liner for example.

Silicones on the other hand typically display a high tensile strength which has a beneficial effect when an especially high degree of lateral deformation is expected in a body part in a lying position. This is especially the case in obese patients. Silicone is also non-toxic and rarely causes an allergic reaction.

Preferably, thermoplastic elastomers can also be used as a base material for the liner if the liner must be subsequently adjusted to the body part since the liner can be subsequently shaped through the application of heat.

An additional embodiment concerns a liner that is preferably formed out of a layer of base material in which particles of contrast medium have been homogeneously distributed, or molecules of contrast medium have been introduced. The contrast medium is preferably in a form or compound that can be mixed homogeneously with the base material in an unpolymerized state. It is advantageous that the added contrast medium does not disturb and/or inhibit the polymerization reaction in the base material. For example, contrast media in ethanolic solvents or contrast media in aromatic compounds are particularly unsuitable for the manufacture of a polyurethane liner. In the manufacturing process of a liner, it is preferential to introduce powdered contrast media into the base material which is subsequently polymerized and as a result, contains the contrast medium. Alternately, the contrast medium can be a liquid. For example, an emulsion of unpolymerized base material and contrast medium can be prepared. It is preferred that the contrast medium accumulate in the interstices of the polymer network so that the steric order is not affected. Alternately, the contrast medium compound can be involved in the chemical polymerization reaction and form a chemical bond with the base material.

According to another embodiment of the invention, the contrast medium is a contrast medium that enhances contrast in two or more imaging procedures. It is preferred that at least two of the imaging procedures be magnetic resonance imaging and computed tomography. For example, a contrast medium can be used that contains water molecules.

Preferably, the contrast medium is a non-toxic substance and/or a substance that cannot be absorbed by the skin in order to achieve a good material compatibility of the liner. In order to increase safety, it can be advantageous to coat the inner surface as well as the outer surface of the liner with a surface layer of the base material without the contrast medium so that a patient and/or orthopedic technician's contact with the contrast medium can be excluded. Alternately, the surface layer can consist of textile fibers or the like.

According to another embodiment of the invention, the contrast medium contains iodine. It is preferable that the iodine compound be potassium iodide. This exists as a solid and can be added to the base material. The iodine causes increased absorption of the X-rays which results in enhanced contrast between the liner and the surrounding skin tissue in the CT.

According to another embodiment of the invention, the mass ratio of the iodine to the base material is at least 1×10⁻⁵. Preferably a minimum concentration of the contrast medium is added to the base material in order to obtain a marked contrast enhancement. The concentration of the contrast medium is increased to such a degree that automated segmentation of the various layers can be done in the images by means of a segmentation algorithm using the three dimensional image data generated on the basis of this contrast enhancement. In order to optimize the segmentation, a concentration of the contrast medium is advantageously selected so that the resulting signal strength of the liner material can be differentiated from tissue types that are to be segmented such as skin, muscle or bone, making it possible to clearly assign pixels to the liner and/or to a tissue type. It is preferential that the liner material provides a signal strength that falls between the signal strength of the muscle tissue and the signal strength of the bone tissue in CT measurements.

According to another embodiment of the invention, the contrast medium contains glycerol trinitrate. In one particular embodiment of the invention, the minimum mass ratio of the glycerol trinitrate to the base material is 4×10⁻⁵, in which the targeted contrast enhancement between the layer of the skin and the liner is noticeable in the MRI slices. It is preferential that the concentration of the glycerol trinitrate is increased to the optimal value so that an automatic segmentation process can be performed which detects the external surface of the body part formed by the skin layer. In the case of MRI images as well, it is preferential to increase the signal strength of the liner material by means of the contrast medium to a value that falls between the signal strength of bone and muscle tissue. In any event, the signal strength is different enough from the signal strength of the types of tissue being segmented that it allows for a clear assignment of pixels to the liner material during segmentation.

According to another embodiment of the invention, an additional contrast medium is distributed homogeneously in the base material of the liner for an additional imaging procedure, wherein the contrast media contained in the liner do not substantially impair one another's contrast-enhancing effect. In particular, it may be economically advantageous to be able to use a liner universally in multiple different imaging procedures. In the case of a liner that is custom-made for a patient, it makes sense for cost-related reasons to manufacture the base material with different contrast media so that the same liner can be used in different examinations or to answer different questions. Consequently, there is no involved production of a new liner for different imaging techniques. In addition, in terms of the production of a liner, only one manufacturing method need be developed for a combination of multiple contrast media in a liner. This saves both time and expense.

According to another embodiment of the invention, the liner is designed like a stocking and is open either at one or both ends. In the case of the stocking shape that is only open on one side, the liner is preferably placeable on limb stumps, especially a thigh stump, like a stocking. This embodiment is alternately suited for use on upper arm, lower arm and lower leg stumps.

The shape of the stocking-like liner can be adjusted as desired depending upon the stump's particular physiological conditions by using a different matrix for the manufacturing process with press, casting or injection molding. The matrix shapes can advantageously be standard shapes that can be used for a variety of different patients. Preferably, a liner shape can also be manufactured individually for a patient, especially if a replica of the stump shape cannot be obtained using a standard matrix.

The entire surface of the stump can be reproduced with the stocking liner that is closed on one end, especially the contour of the scar tissue at the amputation site. This is particularly advantageous when it comes to precisely determining the surface shape of the stump in order to identify sensitive and stressable areas of the surface. Preferably, the result of these studies can be referenced in the manufacture of a prosthetic socket.

An alternative embodiment is the stocking liner shape that is open at both ends. What is advantageous about this liner shape is that it can be placed in any position on a limb and/or limb stump. This is of particular advantage if a limb is to be imaged in an area that is close to the body so that the limb can be separated from the surrounding tissues of the body. In addition, various standard shapes can be used with a variety of patients. By selecting a standard shape of the liner with a specific base material, the orthopedic technician can determine how well the surface of the limb should be reproduced and/or how well the limb should be kept in the shape that corresponds to its upright position.

An additional embodiment concerns a liner in that shape of a strip which can be wrapped around a body part like a bandage or wrap. This allows the orthopedic technician to individually adjust the pressure and/or tractive force exerted on the body part by the liner by wrapping the liner either more tightly or loosely around the body part.

According to another embodiment of the invention, the thickness of the liner material is at least 5 mm. In order to optimize the base material's macroscopic, mechanical properties that are based on the interaction of the macromolecules at a microscopic level such as tensile strength, ductility and/or rigidity, the liner material must have a sufficient minimum thickness. A minimum thickness of approximately 5 mm has proven to be particularly advantageous in its use in imaging procedures because of the image resolution that is typically employed.

Another aspect of the invention concerns the use of a liner according to the invention in a traction device to simulate the weight acting on a body at various flexion angles largely parallel to the longitudinal axis of the body part during an imaging procedure.

The traction device includes a height-adjustable deflection pulley, by means of which a tension predefinable in terms of direction and strength is exertable by a tension cable and a weight on the liner attached to the tension cable so that different flexion angles of the body part encased in the liner can be adjusted relative to the body. It is advantageous that force can be exerted on a body part, especially a stump, by using the traction device with the liner. This force essentially corresponds to the weight of the stump that would act on the stump were it in an upright position.

The tension cable is advantageously made of a non-elastic material such as a textile fiber or leather. The tension cable can be connected at both ends to the weight and/or the liner using eyelets and hooks, and any other connection is possible.

The tension cable exerts a tractive force on the liner which, as a result of the form-fitting connection with the encased stump, ideally deforms the stump the same way in a lying position during an imaging procedure as the stump would be deformed in an upright position. The resulting shape and position of the tissue in the stump is imaged during the imaging procedure and can be used advantageously in the creation of a form-fitted prosthesis socket. Preferably the flexion, i.e., the inclination of the stump, can be adjusted in relation to the imaging table on which the patient is lying using the above-described traction device while imaging. The inclination of the stump proceeds from the patient's hip joint. The height of the deflection pulley is adjusted to achieve this. The deflection pulley can be arranged on a stand, or it can be suspended. In this way, the longitudinal axis of the body part is angled relative to the imaging device. It is advantageous that the desired images and/or slices can be obtained in this manner.

An additional aspect of the invention concerns the use of a liner according to the invention to create a virtual 3D models of a body part in a process comprising the following steps: the application of a form-fitting liner to the body part, acquisition of three-dimensional image data of the body part via an imaging procedure, segmentation of the skin surface into three-dimensional image data using the enhanced contrast of the liner material in comparison to the skin tissue of the body part, and reconstruction of a 3D model using the segmented 3D image data where the 3D model describes the surface shape of the body part.

The liners are preferably attached in a form-fitting manner by turning the liner inside out so that the inner wall is on the outside. The inner wall of the liner is then preferably wet or sprayed with an ethanolic solution. This is preferred because it prevents the sides of the liner from sticking to one another. In the case of a stocking liner that is closed at one end made especially for a stump, the liner is placed on the distal end of the stump and then slipped over the stump. Here, care is taken to ensure that no air pockets form.

In the case of a liner that is open at both ends, the liner is first slipped over the body part into the desired position and then unrolled so that here as well, air pockets are not allowed to form between the skin tissue and the inside of the liner.

The patient is subsequently positioned on the imaging table, and image data regarding the stump is recorded. This imaging procedure is preferably an MRI, CT, PET or the like.

The images of the stump generated when a liner according to the invention is fitted are used in the next step of the process in which the skin surface of the stump is segmented. The three-dimensional image data is suited for automated segmentation because of the enhanced contrast between the skin tissue and the liner. In the segmentation, each pixel is assigned to a type of tissue, especially skin tissue. The segmentation algorithm can perform a grayscale separation of the pixels or a similar threshold value analysis. The segmentation can alternately be an edge algorithm. The contrast medium and/or the concentration of the contrast medium can be adapted advantageously to the segmentation algorithm being used in order to obtain optimum segmentation results. Preferably it can be arranged for the user to manually intervene in the segmentation process.

A virtual 3D model of the stump is subsequently generated using the segmented, three-dimensional image data. Preferably this can be achieved using an interpolation method. It is advantageous that the 3D model precisely describes the surface shape of the stump.

According to another embodiment of the invention, the use of the liner to create a 3D model in one procedure also includes a segmentation of the tissue types found in the body part. In addition, the 3D model describes the tissue distribution in the body part. In so doing, it is preferential that the tissue types such as fat, muscle and bone are also segmented during segmentation. The 3D model that describes the entire three dimensional tissue distribution in the stump can then be used advantageously in the creation of a prosthesis socket. Preferably, the 3D model can then be subjected to modification which creates the optimum fit of the socket for the imaged stump. The modification can be carried out automatically using stored, knowledge-based rule sets.

### BRIEF DESCRIPTION OF THE DRAWINGS

Preferred exemplary embodiments of the invention are further described below using the schematic drawings. They show:

FIG. 1a a schematic representation of a liner according to an embodiment of the invention;

FIG. 1b a schematic representation of a liner according to an embodiment of the invention;

FIG. 2a a cross-section of a body part according to the state of the art;

FIG. 2b a cross-section of a body part enclosed by a liner according to an embodiment of the invention;

FIG. 3 a cross-section of a body part and surrounding areas of the body according to an embodiment of the invention; and

FIG. 4 a device for simulating weight according to an embodiment of the invention.

### DESCRIPTION OF PREFERRED EMBODIMENTS

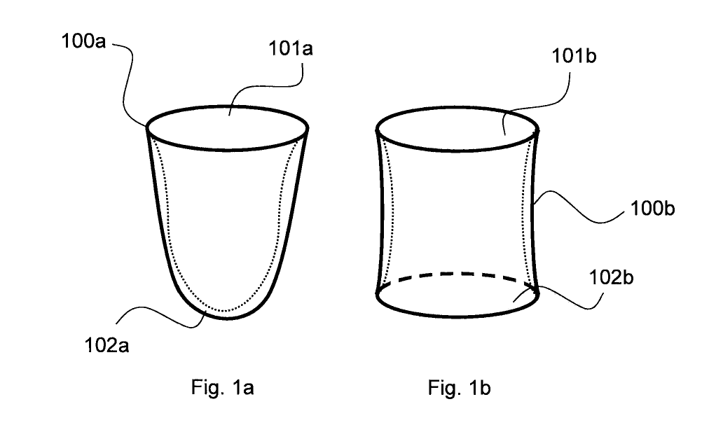

FIG. 1a shows a liner 100a schematically and in particular not to scale. The liner 100a has a basic shape that is cylindrical. The length of the liner and its diameter are not fixed and can be adjusted to the patient's specific needs. In particular, a liner 100a can be made to measure, which may display bulges or constrictions of the lateral surface in specific areas for example. Alternatively, the longitudinal axis of the liner can be curved in order to accommodate the patient's anatomy. The liner has an opening 101a in the proximal region that is used to pull the liner on. The opposite side 102a is curved. In particular, the liner can taper conically to the side 102a. The thickness of the liner material is essentially constant, however it is reduced at the open end. This is used preferably for the imaging of limb stumps with a liner shape that is closed at one end. The wearing of the liner during imaging is especially beneficial in distinguishing the thigh from the genitals in a male patient. In the case of obese patients with a larger body circumference, it is also possible to separate the stump from the buttocks area or stomach tissues using the liner. The surface shape of the stump can be completely reproduced and recorded by means of the curved end of the liner in the distal region. Since the distal end of the stump is also enclosed in liner material, an even pressure is exerted on the stump by the liner. The circumference of opening 101a can also be designed to be elliptical rather than round so that there are different heights on different sides of the liner.

FIG. 1b shows a liner 100b schematically and in particular not to scale. This has two openings 101b and 102b and therefore is especially suited for imaging a completely intact limb. With openings on both sides, it is possible to slip the liner over a hand or foot when putting it on. The position of the liner on the limb is completely arbitrary. Thus the liner may be drawn up the shoulder region of the arm, for example, and the tissue of the arm separated from the surrounding types of tissue in the chest. It may be especially advantageous in distinguishing arm tissue from upper body tissue with the described liner in the case of obese patients with a comparatively large waist circumference. In the liner described above, the dimensions of the top surfaces of any closed curves can be described so that a patient's physiological characteristics can be taken into consideration. The liner can have any ratio of length and diameter. In special cases, the lateral surface can be specially modified. In particular, the liner 100b can taper off conically, narrowing towards the distal opening 102b. The thickness of the liner material is essentially homogenous and can decrease towards the open top surfaces 101b, 102b.

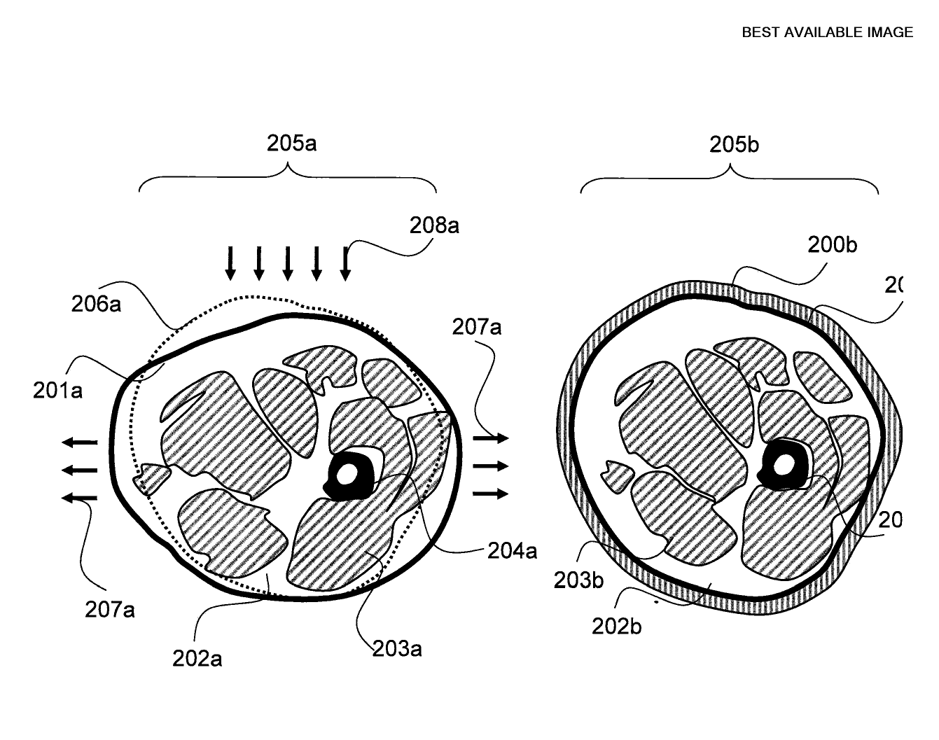

FIG. 2a shows a cross-section of a limb 205a in a horizontal position under the effect of gravity. This cross-section 205a can be an upper arm or thigh cross-section for example. The cross-section 205a shows various types of tissue such as skin 201a, fat 202a, muscle 203a and bone 204a. In the case of a limb in a horizontal position as is common during a medical imaging procedure, there is a lateral deformation 207a and a flattening 208a of the body as a result of the weight that is now exerted perpendicular to the axis of the body. In particular, the position of the tissue being imaged in this way does not correspond to what is natural and the external shape of the body part does not correspond to the natural shape 206a which is represented with dotted lines to clarify the effect. This effect can significantly distort a diagnosis that is to be made based on the images or the results of the three-dimensional geometric measurements of a limb.

FIG. 2b shows a cross-section of a limb 205b in a horizontal position, enclosed in a liner 200b according to an embodiment of the invention. This prevents or reduces a flattening and simultaneous lateral deformation of the limb (see FIG. 2a). The types of tissue contained in the limb of skin 201b, fat 202b, muscle 203b and bone 204b are therefore found in their natural position which corresponds to an upright position of the limb. The external shape also essentially corresponds to this natural shape in an upright position of the body part. In consequence, the results of the socket measurements using the recorded image information are more precise which is beneficial when, for example, manufacturing a prosthesis socket for a patient.

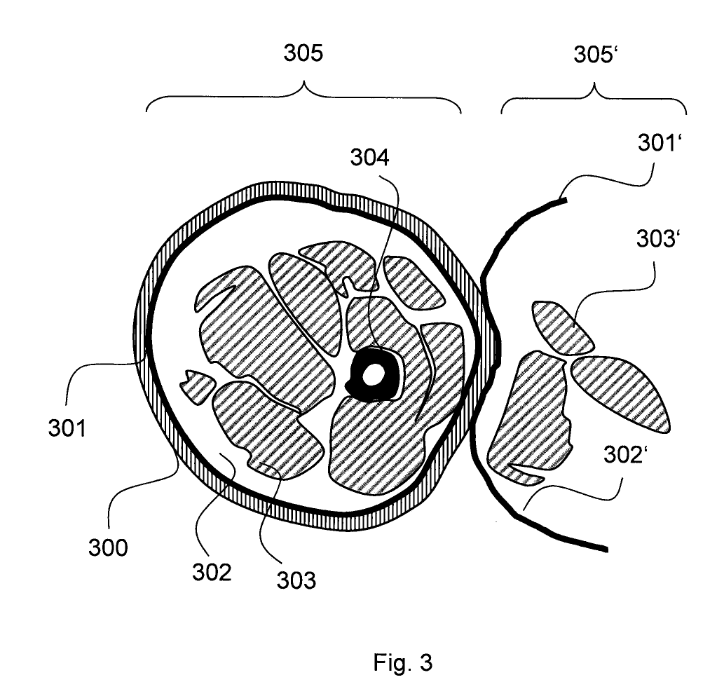

FIG. 3 shows a cross-section of a limb 305 which is enclosed in a liner 300 that holds the limb in a specific shape through the exertion of pressure and essentially secures the position of the tissue 301-304 in the limb. Directly next to the limb there is a surrounding area of the body 305′, for example the male genitals or upper body tissue, which may also contain different types of tissue such as skin 301′, muscle 303′ and fat 302′. The liner 300, which is situated between the skin layers of the limb and the surrounding area of the body, is clearly reproduced in the images as a result of the contrast-enhancing effect of the contained contrast medium, and this makes it possible to separate the layer of skin belonging to the surrounding area of the body from the layer of skin belonging to the limb. The skin surface, which forms the outer surface of the limb, can thus be determined using an automated segmentation algorithm.

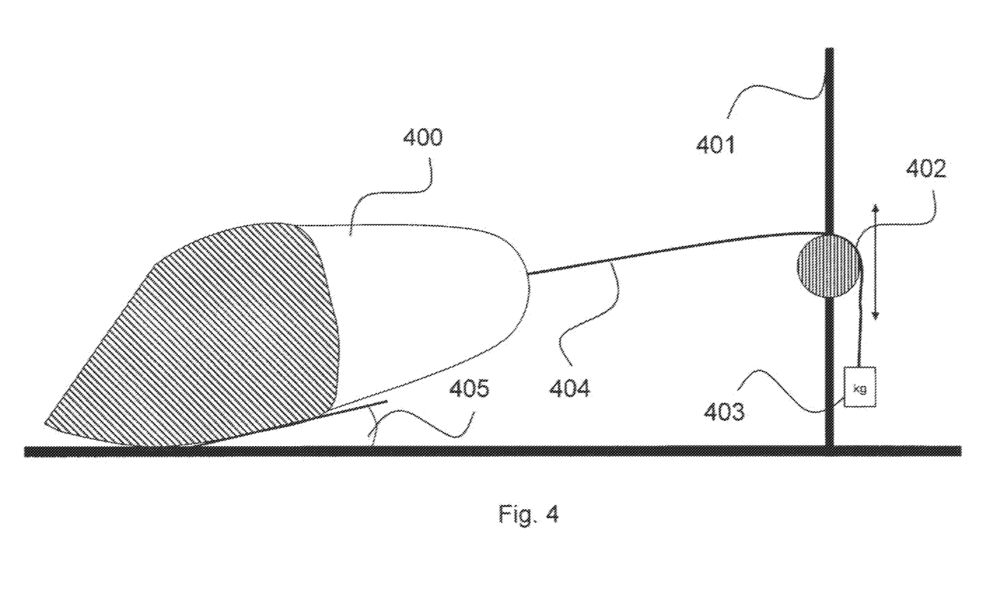

FIG. 4 shows a traction device which can be used during an imaging procedure. The traction device includes a stand 401, a pulley 402, a weight 403 and a cable 404. The pulley 402 is height-adjustable and is attached to the stand 401. By adjusting the height of the pulley, it is possible to adjust the inclination and flexion 405 of the stump being imaged in the imaging device. A flexion of the thigh stump in a range between 5° and 20° is advantageous, for example. The inclination is determined by the orthopedic technician before imaging using the anatomic characteristics of the patient. The weight 403 is connected to the liner 400 via the tension cable. Preferably the tension cable is comprised of a non-elastic material. The tension cable 401 is run over the pulley 402 and causes the weight to be suspended in the air. In this way, the tension cable exerts a tractive force on the liner that essentially acts along the axis of the stump. The mass of the weight advantageously corresponds to the weight that would act upon the upright stump. In this way, images of the stump can be obtained with a shape that essentially correspond to the that of the upright stump.

1. A liner to at least partially enclose a body part during an imaging procedure, wherein the liner is suitable for holding the body part essentially in a specific shape, and wherein the liner can be placed on a skin surface of skin tissue of the body part in a roughly form-fitting manner, wherein the liner has a material that comprises a base material in which at least one contrast medium has been homogeneously distributed which is suitable to enhance a contrast between the liner and the skin tissue in image data that is generated relative to a contrast between the base material and the skin tissue when the liner is used on the body part during the imaging procedure.

2. The liner according to claim 1, wherein the specific shape in which the body part is held is a shape of the body part that appears when the body part is in a specific attitude or position.

3. The liner according to claim 1, wherein the body part is a limb stump and the liner is designed to completely enclose the limb stump.

4. The liner according to claim 1, wherein the base material contains at least one of polyurethane, silicone and thermoplastic elastomer.

5. The liner according to claim 1, wherein the contrast medium enhances contrast In two or more different imaging procedures.

6. The liner according to claim 1, wherein the contrast medium contains iodine.

7. The liner according to claim 6, wherein a mass ratio of the iodine to the base material is at least 1×10⁻⁵.

8. The liner according to claim 1, wherein the contrast medium contains glycerol trinitrate.

9. The liner according to claim 8, whereby a mass ratio of the glycerol trinitrate to the base material is at least 4×10⁻⁵.

10. The liner according to claim 1, wherein at least one additional contrast medium for an additional imaging procedure is homogeneously distributed in the base material of the liner, and the at least one contrast medium and the at least one additional contrast medium do not substantially impair one another with their contrast-enhancing effect.

11. The liner according to claim 1, wherein the liner is formed as a stocking that is open at one or two ends.

12. The liner according to claim 1, wherein a thickness of the liner is at least 5 mm.

13. Use of the liner according to claim 1 in a traction device to simulate weight of a body including the body part acting on the body part at different flexion angles essentially parallel to a longitudinal axis of the body part during the imaging procedure, wherein the traction device includes a height-adjustable deflection pulley by means of which a tractive force from a weight and a tension cable that is predefined in terms of direction and strength can be exerted on the liner, which is attached to the tension cable, so that different flexion angles of the body part enclosed in the liner can be set relative to the body.

14. Use of the liner according to claim 1 to create a virtual 3D model of the body part in a process comprising the steps:
form-fittingly applying the liner on the body part;
acquiring three-dimensional image data of the body part using an imaging procedure;
segmenting the skin surface in the three-dimensional image data based on increased contrast of the liner with respect to the skin tissue of the body part to create segmented 3D image data; and
reconstructing a 3D model using the segmented 3D image data, wherein the 3D model describes a surface shape of the body part.

15. Use of the liner according to claim 14, wherein the process also includes segmenting tissue types contained in the body part, and the 3D model describes a distribution of tissues in the body part.
